(19) United States
(12) Patent Application Publication
(10) Pub. No.: US 2013/0142019 A1
(43) Pub. Date: Jun. 6, 2013

(54) VEHICULAR APPARATUS AND MUSIC PIECE ACQUISITION SYSTEM

(71) Applicant: DENSO CORPORATION, Kariya-City (JP)

(72) Inventor: Tetsuo ITOU, Nagoya-city (JP)

(73) Assignee: DENSO CORPORATION, Kariya-city (JP)

(21) Appl. No.: 13/687,115

(22) Filed: Nov. 28, 2012

(30) Foreign Application Priority Data
Dec. 2, 2011 (JP) 2011-265132

(51) Int. Cl. G11B 31/00

(52) U.S. Cl. CPC G11B 31/003
USPC 369/7

(57) ABSTRACT

A vehicular apparatus in a traveling vehicle automatically records, to a storage device, a tag data and a place and time data associated with the tag data. The place and time data respectively representing a place and a time a music piece that corresponds to the tag data recorded under control of a control unit was played. The control unit displays the tag data together with the place and time data, which is associated with the tag data, on a display unit for reminding a user of the music piece associated with the tag data, without distracting the user from the drive operation of the vehicle.

### CROSS REFERENCE TO RELATED APPLICATION

The present application is based on and claims the benefit of priority of Japanese Patent Application No. 2011-265132, filed on Dec. 2, 2011, the disclosure of which is incorporated herein by reference.

### TECHNICAL FIELD

The present disclosure generally relates to a vehicular apparatus and a music piece acquisition system including the vehicular apparatus.

### BACKGROUND

A vehicular apparatus is known to receive a music data of a music piece and collateral data identifying the music piece, which may be broadcasted at the same time. For example, Japanese Patent Laid-Open No. 2009-239552 discloses an in-vehicle audio system device receiving music data of a music piece together with its tag data, which are broadcasted by a digital broadcast station. The tag data includes information about the music piece, such as an artist name, an album name, a music piece title, and a genre of the music piece.

In recent years, a technique for the vehicular apparatus to record the tag data together with sound data of the music piece while the music piece is being broadcasted by a broadcasting station is known. In addition, transmitting the tag data to a portable terminal (e.g., a cellular phone) from the vehicle apparatus according to an operation of a button positioned on the vehicle apparatus is also known. In such technique, the portable terminal receives the tag data and displays the tag data, which is sorted as list, on a screen of the portable terminal. Thus, the user of the terminal is allowed to download the music piece to the portable terminal based on the list of the tag data displayed thereon.

However, in the above-described conventional technique, the user has to timely operate the button on the vehicle apparatus if the user intends to record the tag data (i.e., the collateral data) of a music piece. In other words, the button has to be operated when the music piece is being broadcasted from the station.

Such requirement for recording the collateral data leads to the following problems. For instance, if the user is driving a vehicle, operating the button on the vehicle apparatus may distract the user's attention away from the driving operation. In addition, if the user is concentrated on the driving operation, the user may forget to operate the button on the vehicle apparatus while the music piece is being broadcasted, thereby failing to record the collateral data of the favorite music piece.

The collateral data of the music piece being broadcasted may be automatically recorded on the apparatus when the vehicle is traveling, and the auto-recorded collateral data may be later selected by the user when the vehicle is not traveling. In such manner, the user may safely select and download the music piece to the terminal. However, even in such case, the user may find it difficult to identify a desired music piece based only on the collateral data. More practically, if the user does not know the artist name, music title, or the like of the music piece desired, the user cannot associate the collateral data with the music piece. Therefore, even when the collateral data is recorded on the apparatus, the user cannot identify the desired music piece.

### SUMMARY

In an aspect of the present disclosure, a vehicular apparatus may be used in a vehicle to play a music piece based on sound data of the music piece. The vehicular apparatus includes: a broadcast data acquisition unit, a travel position detection unit, a place data acquisition unit, a record unit, and a display control unit.

The broadcast data acquisition unit acquires collateral data of the music piece together with the sound data. The collateral data and the sound data of the music piece are broadcasted together by a broadcast station, and the collateral data may be used to identify the music piece.

The travel position detection unit detects a travel position of the vehicle, and the place data acquisition unit acquires place data regarding a place. The place serves as an approximate indicator of the travel position of the vehicle detected by the travel position detection unit.

The record unit automatically records the collateral data acquired by the broadcast data acquisition unit and the place data acquired by the place data acquisition unit when the vehicle is traveling. The place data provides the place around which the travel position of the vehicle is located at a time the music piece associated with the collateral data acquired by broadcast data acquisition unit is played. The display control unit displays the place data on a display unit in association with the collateral data recorded by the record unit.

Based on the present disclosure, the vehicular apparatus automatically records the collateral data while the vehicle is traveling. In other words, the user does not have to perform a specific operation (i.e., to operate a button on the apparatus) to record the collateral data while driving the vehicle. Therefore, the user will not be distracted from driving the vehicle and the collateral data will not be left unrecorded.

Accordingly, the collateral data is displayed in association with the place data that is representative of the place around which the music piece was played. The display of such place with the collateral data is intended to help the user to recall the music piece itself with which the collateral data is associated. In other words, the place data is used as a cue to recall a travel position of the vehicle at a time of playback of the music piece with which the collateral data is associated. If the user recalls where he/she was traveling at a time of playback of the music piece, the title and/or other attributes of the music piece could then be recalled. As a result, the user is enabled to associate the collateral data with the music piece.

A travel position of the vehicle serves as a strong clue, or a cue, from which the user's memory recalls the music piece played back, since both of the preferable music piece to which the user was listening and the travel position, or, a scenery, in which the user was immersed are a broad and recallable basis of the user's memory. In other words, the music piece and the travel position can easily be reduced to a sequence of memorable scenes, in which the user is mildly objectively traveling. Therefore, it may be easy for the user to recall the name of the place that is associated with the music piece of his/her preference.

As a result, recording of the collateral data associated with the music piece is performed without disturbing the user's concentration on driving the vehicle, and the user is easily enabled to recall and associate the collateral data with a certain music piece based on the travel position of the vehicle.

### BRIEF DESCRIPTION OF THE DRAWINGS

Other objects, features and advantages of the present disclosure will become more apparent from the following detailed description disposed with reference to the accompanying drawings, in which:

FIG. 1 is a block diagram of a music piece acquisition system of the present disclosure;

FIG. 2 is an illustration of a transmission scheme of tag data from a broadcast center;

FIG. 3 is a block diagram of a navigation apparatus;

FIG. 4 is a block diagram of a portable terminal;

FIG. 5 is a flowchart of a tag data record process performed by a control unit of the navigation apparatus;

FIG. 6 is an illustration of a screen displayed by a detail display process; and

FIG. 7 is an illustration of a screen at a time of manual tag data recording.

### DETAILED DESCRIPTION

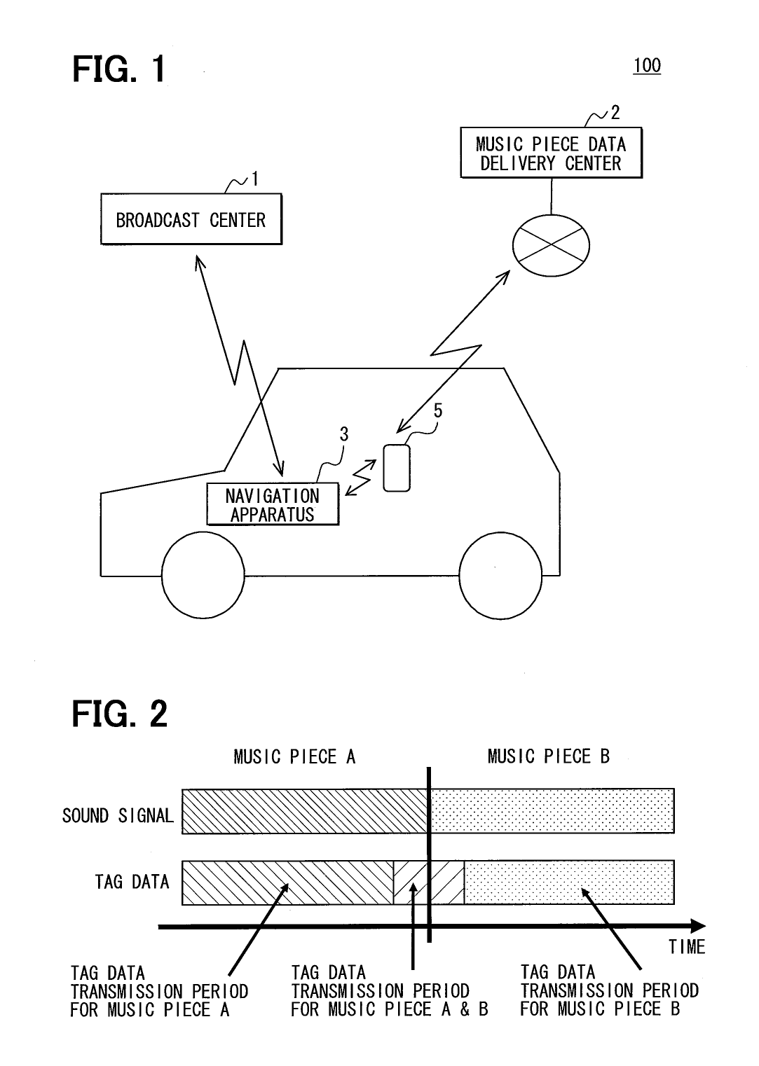

An embodiment of the present disclosure is described with reference to the drawings in the following. With reference to FIG. 1, a music piece acquisition system 100 includes a broadcast center 1, a music piece data delivery center 2, a navigation apparatus 3, and a portable terminal 5.

The broadcast center 1 is a broadcasting station of a digital radio (i.e., a digital sound broadcast station), and broadcasts a music program in which a plurality of music pieces are played. Specifically, the broadcast center 1 transmits sound data (i.e., a sound signal) of the music piece and transmits a tag data that uniquely identifies the music piece. The sound data of the music piece being broadcasted by the broadcast center 1 may be, for example, delivered from the music piece data delivery center 2 to the broadcast center 1.

The tag data is information that is collateral to the music piece and, therefore, does not include the sound data of the music piece itself. The tag data may include, for example, the title of the music piece (i.e., a song), the music piece ID number, the artist name, a genre of the music piece, a broadcast channel, and a tone of the music piece. The tag data may be referred to as collateral data in claims.

With reference to FIG. 2, details of the transmission of tag data from the broadcast center 1 is provided. In this case, the broadcast center 1 is assumed to broadcast a music program in which a music piece A and a music piece B are played back.

When the music piece A and the music piece B are broadcasted in this order, the sound signal of the music piece B is transmitted from the broadcast center 1 after the transmission of the sound signal of the music piece A, in a discrete manner, i.e., one by one. In addition, the tag data of the music piece A, which is transmitted during the broadcast of the music piece A, is further transmitted for a certain period of time after the start of transmission of the sound data of the music piece B. The broadcast center 1 starts to transmit the tag data of the music piece B before the start of transmission of the sound signal of the music piece B and prior to the end of transmission of the sound signal of the music piece A or, in other words, while the sound signal of the music piece A is being broadcasted.

In FIG. 1, for the illustration purposes, only one broadcast center 1 is provided in the music piece acquisition system 100. However, the number of the broadcast center 1 in the system 100 may be more than one. In the following, a plurality of broadcast centers 1 are assumed to be included in the music piece acquisition system 100, and each of the broadcast centers 1 having a separate channel, assigned thereto, for allowing each broadcast center 1 to broadcast a different program.

Further, in the present embodiment, the broadcast center 1 is shown as a broadcasting station of digital radio. However, the broadcast center 1 may be other than a digital radio station. The broadcast center 1 may be a satellite radio broadcasting station, or may be a digital television broadcasting station, as long as the station broadcasts the tag data together with the sound data of the music piece. Further, the broadcast may include a delivery of the music piece through the Internet. In such case, the broadcast center 1 may be an Internet radio broadcast station.

The music piece data delivery center 2 is implemented as a server, and maintains the sound data of a plurality of music pieces and a music piece information regarding such music pieces. The music piece information may be information such as a title of a music piece (i.e., a song), a music piece ID number, an artist name, a genre of the music piece, a tone of the music piece, and a ranking number of the music piece in a hit chart.

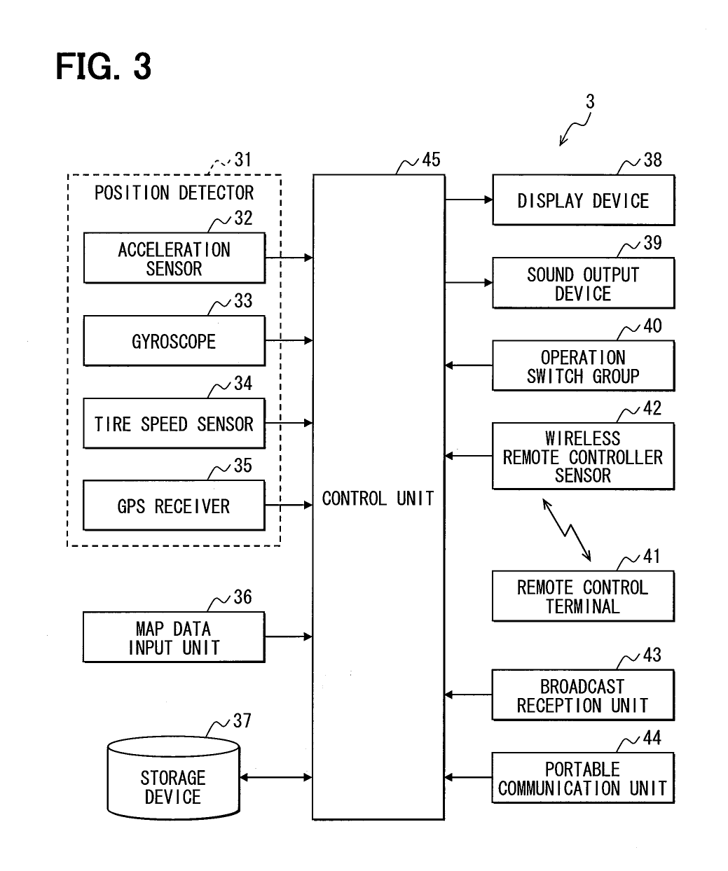

The navigation apparatus 3 is fixedly or movably installed in the vehicle, for use in the vehicle. A block diagram of the navigation apparatus 3 is shown in FIG. 3. For the brevity of description, the conventional, or well-known functions are omitted from the following description.

The navigation apparatus 3 includes a position detector 31, a map data input unit 36, a storage device 37, a display device 38, a sound output device 39, an operation switch group 40, a remote control terminal (i.e., a wireless remote controller) 41, a wireless remote controller sensor 42, a broadcast reception unit 43, a portable communication unit 44 and a control unit 45 as shown in FIG. 3.

The position detector 31 includes an acceleration sensor 32 detecting the acceleration of the vehicle, a gyroscope 33 detecting the angular velocity around the vertical axis of the vehicle, a tire speed sensor 34 detecting the speed of the vehicle from the rotation speed of each of the tires, and a GPS receiver 35 positioning the vehicle based on the electric wave from a GPS (i.e., Global Positioning System) system satellite, for determining a current position of the vehicle.

Further, each of the sensors 32 to 35 has an error of different nature, thereby compensating with each other for the improvement of positioning accuracy. The sensors 32 to 35 may selectively be used to organize the position detector 31, depending on their accuracy, or further compensated by using other sensors.

The map data input unit 36 is a device to input, from a map data medium, various kinds of data including map matching data, map data, and landmark data. In this case, the map data includes road data, background data, and text data. Further, as a data storage medium, a CD-ROM, a DVD-ROM, a memory card, an HDD, or the like may be used.

The road data includes link data and node data representing road segments and intersections/branch points. Links stored as the link data are representation of connections between nodes, which are then used as representation of road intersections, branch points, and merge points. By using links and nodes, roads on the map are topologically/geometrically represented.

The link data includes a link ID number for identifying a link, a link length, link shape information, a link segment length, a link start and end point coordinate (i.e., latitude and longitude), a road name, a road classification, a road width, the number of traffic lanes, presence of a light/left turn exclusive lane, the number of such exclusive lanes, and the speed limit. The node data includes a node ID number for identifying a node, a node coordinate, a node name, a connecting link connected to the present node, and an intersection type.

Further, the background data is data that associates a facility or a geographic feature with position coordinates on the map. The text data is data for displaying a place name, a facility name, a tourist destination name, and a road name, associated with a position coordinate, for displaying the text on the map.

The storage device 37 is an electrically-rewritable non-volatile memory. As the storage device 37, a large capacity storage medium such as a hard disk drive (HDD) may be used. Alternatively, a relatively-small removable memory may be used as the storage device 37.

The display device 38 displays a text and an image, and may be provided as a liquid crystal display, an organic electroluminescence display, and a plasma display. Further, the display device 38 may be a part of the navigation apparatus 3 or may be separately provided as an independent unit.

The sound output device 39 includes speakers and outputs a sound based on instructions from the control unit 45.

The operation switch group 40 may be touch switches provided integrally on the display device 38, or may be mechanical switches provided on a console or the like. By operating the switch group 40, the user can input instructions and data to control various functions of the control unit 45.

The wireless remote controller 41 has multiple operation switches (not illustrated), for the input of various instruction signals, to the control unit 45, according to the operation of the operation switches and through the wireless remote controller sensor 42.

The broadcast reception unit 43 has an antenna with which a broadcast wave or an airwave from the broadcast center 1 is received. The wave received is decoded, and the sound signal and the tag data extracted therefrom are output to the control unit 45. Further, the airwave may be transmitted from a base station. When the broadcast center 1 is an Internet radio broadcast station, an in-vehicle communication module such as a data communication module (DCM) for telematics communication may be used for the reception of the sound signal and the tag data.

The portable communication unit 44 performs communication (i.e., a BT communication) according to a Bluetooth (a registered trademark) standard with the portable terminal 5. The communication between the navigation apparatus 3 and the portable terminal 5 may also be performed according to other standards, such as ZigBee (a registered trademark: a short range wireless communication standard) and IEEE 802.11 (a wireless LAN standard). Further, the communication between the navigation apparatus 3 and the portable terminal 5 may also be performed through wired connection, such as a USB connection.

The control unit 45 is implemented as a computer, including a bus line (not illustrated) for connecting a well-known CPU, ROM, RAM, input/output (I/O) and other parts provided in the computer.

The control unit 45 performs various processes for realizing a navigation function and a tag data recording function. Such processes are based on information received from various components such as the position detector 31, the map data input unit 36, the storage device 37, the operation switch group 40, the wireless remote controller sensor 42, and the broadcast reception unit 43. The control unit 45 may be provided as a vehicular apparatus in claims.

The control unit 45 plays back, in a vehicle compartment, the music piece by outputting, to the sound output device 39, the sound signal of the music piece that has been acquired by the broadcast reception unit 43.

Further, the control unit 45 makes a reservation of a music program by using the broadcast reception unit 43 according to an operation input from the user to the operation switch group 40. In other words, the acquisition (i.e., recording) of the sound data and the tag data regarding a desired music program is reserved. For instance, a channel on which, as well as, a time slot at which the desired music program is broadcasted are set as the reservation. Therefore, the music program according to the time slot and channel set in the reservation is recorded. Accordingly, the control unit 45 may be referred to as a reservation unit in claims.

Further, the control unit 45 performs a pairing process for establishing the BT communication between the navigation apparatus 3 and the portable terminal 5. In case there are multiple portable terminals 5 within the communication range, the control unit 45 performs the pairing process with all of the portable terminals 5. By performing the pairing process, the control unit 45 registers each of the portable terminals 5 (i.e., registration of a user).

The portable terminal 5 is assumed to have many functions, such as a communication function for communicating with an external device, an email function, an Internet connection function (i.e., a web connection function), a music player function, a picture viewer function, a movie playback function, and a navigation function. The portable terminal 5 may be equipped with a touch panel for a touch input. Further, the portable terminal 5 may be a personal digital assistant (PDA) type device or a tablet type computer.

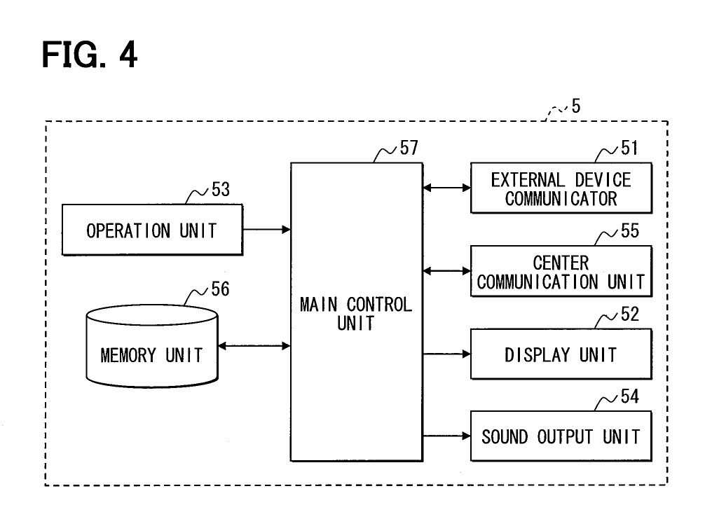

FIG. 4 is now used to describe the configuration of the portable terminal 5. For the brevity of description, only the relevant portion of the portable terminal 5 regarding the present disclosure is described in the following.

The portable terminal 5 includes, as shown in FIG. 4, an external device communicator 51, a display unit 52, an operation unit 53, a sound output unit 54, a center communication unit 55, a memory unit 56 and a main control unit 57.

The external device communicator 51 performs, for example, the above-described BT communication with the navigation apparatus 3. The communication between the navigation apparatus 3 and the portable terminal 5 may be other than the BT communication, as having been described above, such as a wireless communication other than BT communication or a wired communication.

The external device communicator 51 receives data transmitted from the navigation apparatus 3, and inputs the data to the main control unit 57. Further, the external device communicator 51 transmits data that is output from the main control unit 57 to the portable terminal 5, according to instructions from the main control unit 57.

The display unit 52 displays various screens according to various application programs of the portable terminal 5. The display unit 52 is implemented as a full color display unit capable of displaying various colors on the screen, and may be a liquid crystal display, an organic electroluminescence display, and a plasma display.

The operation unit 53 receives an operation by the user for inputting various operation instructions to control the various functions of the main control unit 57. The operation unit 53 may be, for example, a touch switch integrally provided with the display unit 52 or a mechanical switch installed thereon.

The sound output unit 54 includes speakers and outputs a sound according to the instructions from the main control unit 57.

The center communication unit 55 communicates with the music piece data delivery center 2 through communication networks such as a mobile telephone network, and the Internet.

The memory unit 56 is an electrically-rewritable non-volatile memory, for storing various kinds of data. For example, the memory unit 56 stores a sound source, which is a collection of multiple music pieces compressed by using a certain data compression format such as MP3, a music piece information regarding each of the music pieces in the sound source, and a preference information regarding a user's preference of the music piece.

The music piece information may be information such as a title of the music piece (i.e., a name of a song), a music piece ID number, an artist name, a genre of the music piece, a tone of the music piece, the number of playbacks of the music piece by the user, and the ranking number on a hit chart.

The preference information may be information regarding the preference of each user. The preference information may be information such as the number of playbacks of a certain music piece, as well as, the statistics about the genres, the tones, and the artists against the total number of playbacks. The preference information may be represented as, for example, numerical information of the number against the total number of playbacks (i.e., a ratio).

The main control unit 57 is implemented as a normal computer, and, such computer includes, for example, a bus line (not illustrated) to connect a well-known CPU, ROM, EEPROM, RAM, I/O, and other components.

The main control unit 57 performs various processes, based on information provided from the external device communicator 51, the operation unit 53, the center communication unit 55, and the memory unit 56.

The processes performed by the main control unit 57 may be, for example, a counting process and a rank acquisition process. The counting process counts the number of playbacks regarding each of the music pieces and stores the number as the music piece information in the memory unit 56. The rank acquisition process acquires the ranking number of a certain music piece from the music piece data delivery center 2 through the center communication unit 55 and stores the ranking number of each of the music pieces in the memory unit 56 as the music piece information.

Furthermore, the main control unit 57 stores, in the memory unit 56, the preference information regarding the preference of the number of playbacks of the music pieces, as well as, the artist, genre, music key/tone statistics. Furthermore, the main control unit 57 reads the preference information from the memory unit 56, and transmits the preference information to the navigation apparatus 3 through the external device communicator 51.

The details of the recording of the tag data by the control unit 45 of the navigation apparatus 3 is described in the following.

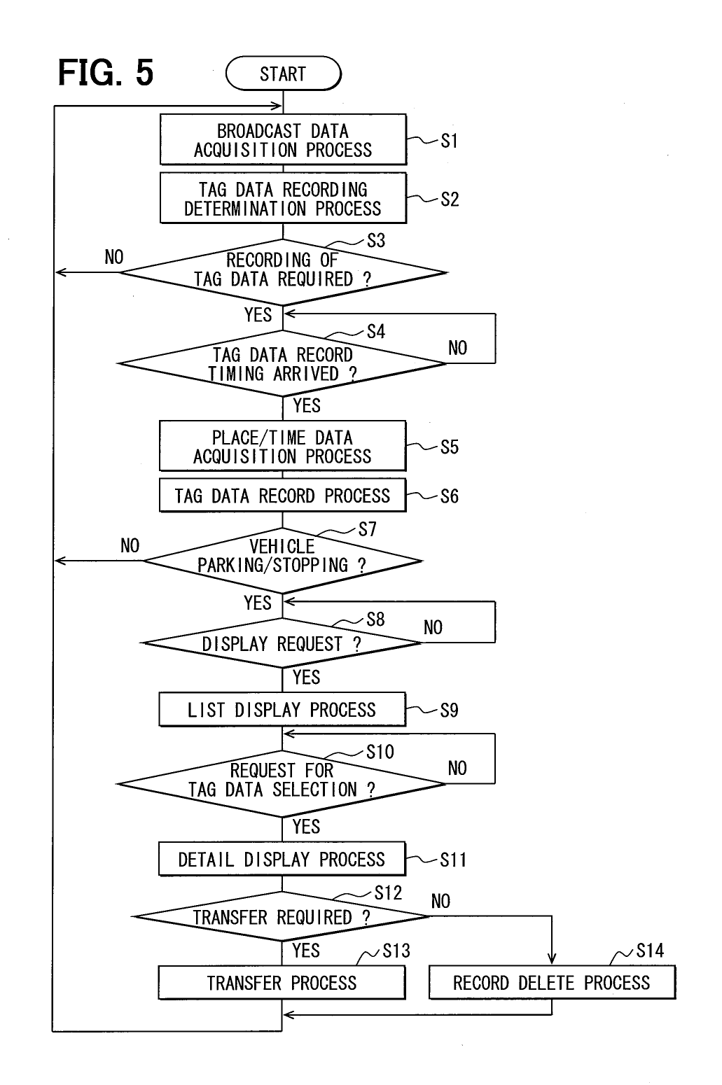

FIG. 5 is a flowchart of a tag data record process performed by the control unit 45 of the navigation apparatus 3. The tag data record process is started, for example, at a time of turning on an accessory power supply (i.e., an ACC power supply) of the vehicle.

At S1 a broadcast data acquisition process is performed to acquire a sound signal and tag data (i.e., broadcast data hereinafter) from the broadcast center 1 by using the broadcast reception unit 43. The control unit 45 may be referred to as a broadcast data acquisition unit in claims.

At S2 a tag data recording determination process is performed to determine whether the recording of the tag data is required for the music piece corresponding to the broadcast data currently being received from the broadcast center 1. For instance, when the music piece currently being received corresponds with the user preference, the control unit 45 determines that recording of the tag data of such music piece is required. The control unit 45 may be referred to as a preference inference unit in claims.

The user preference may be inferred by the control unit 45 based on the preference information acquired by the portable communication unit 44 from the portable terminal 5. For example, based on the number of playbacks of a certain music piece, the number of playbacks of music pieces that are composed by a certain artist, the number of playbacks of music pieces in a certain genre, or the number of playbacks of music pieces having a certain music tone, the music pieces having an above-threshold number of playbacks are inferred as user preferred music pieces. Further, when the number of playbacks of a certain music piece having a certain attribute (i.e., an artist, a genre, or a tone) tops the number of playbacks among the music pieces in the same category, such music piece may be inferred as a user preferred music piece, or, more specifically, a music piece having a preferred artist, genre, or tone.

Further, when the preference information is numerical information, an above-a-threshold number in the numerical information, besides the number of playbacks, may also be used to infer the user preference of the music piece title, artist, genre, or tone. That is, the number topping the category may also be used to infer the user preference.

The preference information may also be inferred based on the user setting. For instance, when the user operates the operation switch group 40 or the wireless remote controller 41 to input his/her preference regarding the preferred artist, genre, tone or the like, the user setting operation performed in such manner is set and stored as the preference information.

Other preference setting schemes may be devised. For example, when the user, such as a driver, is detected to have a certain vital reaction or is detected to perform a certain driving operation, recording of the tag data of a music piece played back at such moment may be determined as required. More practically, when the user is detected to have recovered from sleepiness, or, when the user is detected to have an improved concentration, the preference setting scheme may determine that the tag data recording of the music piece causing such condition or such condition change is required. In other words, when a positive mood/condition of the user or a positive change of user condition, presumably caused by listening to a preferred music piece, is detected, it may be determined that the recording of the tag data of such music piece is required for picking up such positive user condition or positive change of user condition.

For instance, the sleepiness of the driver and the recovery therefrom may be detected by the control unit 45 based on a camera captured image of the user's face by using a well-known method. The concentration and fatigue of the driver may be detected by the control unit 45, for example, based on the camera captured driver's face image, or based on the steering wheel operation performed by the driver.

Further, recording of the tag data of the music piece played back at such moment of positive user condition or positive change of user condition may be determined as required when, for example, the driver exhibits an improvement of the driving operation, indicating a positive mood/condition, or a positive change of condition. Such user condition or change of user condition may be detected and evaluated by the control unit 45 by using a well-known method based on the sensor signals from various sensors and/or the camera-captured images regarding the surrounding of the vehicle. Accordingly, the control unit 45 may be referred to as a driver condition detection unit in claims.

The music program being reserved for recording may be used to pick up the preferred music pieces. That is, it may be determined that recording of the tag data of the music pieces played back in reserved music program is required.

The music pieces that are in accordance with a certain travel environment of the vehicle may be determined as tag data recording required music pieces. The travel environment of the vehicle may be determined based on the geographical features around the travel position of the vehicle, as well as, the weather and the time of day.

The geographical feature may be represented as a city, a town, an urban area as well as a mountain and a sea. Such feature may be detected by the control unit 45 based on the map data and the travel position of the vehicle.

The weather may be classified as fine weather, cloudy weather, rainy weather, and the like. Detection of the weather may be performed by the control unit 45 based on the reception of weather information from a weather information center by the broadcast reception unit 43 or the wireless communication device.

The detection of the weather and its accordance with the music tone or the like may more practically be performed in the following manner. The types of travel environment (i.e., the weather types or the like) may be stored in advance in a non-volatile memory such as ROM, EEPROM, in association with an artist, a genre, a tone of the music pieces (i.e., music feature information, hereinafter) in a table format. In such table format, the geographical, for example, feature “sea” may be associated with a genre “classical music,” the geographical feature “urban area” may be associated with a genre “pop music,” a weather “fine” may be associated with a “bright” music tone, a weather “rain” may be associated with a “gloomy” music tone, a “day” time may be associated with a “bright” music tone, and a “night” time may be associated with a “romantic” music tone.

The control unit 45 acquires the music feature information corresponding to the travel environment detected representing the geographical feature, the weather, or the time of the day with reference to the table of information. Recording of the tag data is determined as required when the music piece has the tag data that includes the same music feature information as the music feature information of the travel environment detected. Accordingly, the control unit 45 may be referred to as a travel environment detection unit in claims.

In an example of the table of music feature information, when the geographical feature “sea” is currently being detected, the genre “classical music” is acquired with reference to the table, and then tag data recording is determined as required if the music piece has the tag data that classifies it as “classical music.”

The tag data recording criteria, which are used for determining whether recording of the tag data is required or not, are described as conditions surrounding the vehicle. The conditions may be individually used, or may be used in combination. All of the conditions may be used at the same time, or additional conditions may also be introduced. For example, it may be determined that the tag data of a top-ranked music piece is required.

Further, the control unit 45 determines that the recording of the tag data is not required when none of the conditions are fulfilled.

With continuing reference to FIG. 5, at S3, the control unit 45 determines whether the recording of the tag data is required based on the tag recording determination process. When the recording of the tag data is required (S3, YES), the control unit 45 proceeds to S4. When the recording of the tag data is not required (S3, NO), the control unit 45 returns to S1.

At S4, the control unit 45 determines whether a tag data record timing has arrived. More practically, when switching of music pieces is detected (i.e., transition from one music piece that is being played to another music piece that is to be played next) or when switching of channels for receiving a broadcast of a music program is detected, it is determined that the tag data record timing has arrived. The switching of the played back music pieces may be detected based on a reception of a music piece playback end signal, or may be detected based on a switching of the tag data acquired (i.e., when the tag data of a subsequent music piece is being received).

Further, the tag data record timing may be determined based on a detection of turning off of the ACC power supply. In such case, the tag data that has been acquired just before the detection of turning off of the ACC power supply or approximately at the detection of turning off of the ACC power supply may be recorded by using, for example, a backup power supply, before finishing the flowcharted process.

When it is time to record the tag data (S4:YES), the control unit 45, at S5, performs a place and time data acquisition process, and proceeds to S6. The place and time data acquisition process identifies the current position (e.g., longitude/latitude) of the vehicle detected by the position detector 31 as a travel position of the vehicle. The control unit 45 may be referred to as a travel position detection unit in claims.

The place and time data acquisition process also acquires place data regarding a place that serves as a rough indication of the travel position of the vehicle identified by the travel position detection unit. In addition, time data regarding a time of day that is either of a current time or a time slot in which the current time falls under the current time is acquired. The control unit 45 may be referred to as a place data acquisition unit and a time data acquisition unit in claims.

The place data is a travel section including an identified travel position, a name of a place/sight/facility that is close to the identified travel position. The travel section may be determined as a section corresponding to a link in the map data. The place data corresponding to the identified travel position may be acquired as the identified travel position and the map data, such as link data and the name of the place/sight/facility/road, which may be recorded as text. In the present embodiment, the place data is exemplarily described as the name of a place that is close to the identified travel position.

The time data may be acquired as a time that is measured by a time measurement device installed in the vehicle, which is not illustrated in the drawing. The time data may be a time of day, which can be acquired directly from the time measurement device. The time data may be a time slot that includes a time measured by the time measurement device. The time slot may be a time between “13 to 14,” or a “morning/day/evening/night” or the like, roughly designating a certain period of time.

At S6, the control unit 45 performs a tag data record process. The tag data record process records, to the storage device 37, the tag data that has been determined as recording-required in association with the place and time data acquired by the place and time data acquisition process. Each time the flowcharted process of FIG. 5 including the tag data record process is repeated, a new combination of the tag data and the place and time data is recorded to the storage device 37.

Further, the place data recorded in association with the tag data is the place data regarding the travel position of the vehicle at a time of playback of a music piece corresponding to such tag data, and the time data recorded in association with the tag data is the time data regarding the time of playback of a music piece corresponding to such tag data. Accordingly, the control unit 45 may be referred to as a record unit in claims.

The control unit 45, at S7, determines whether the vehicle is parking or stopping. Whether the vehicle is stopping/parking is determined based on, for example, the speed of the vehicle. For instance, when the speed of the vehicle is substantially equal to zero (e.g., 5 km/h or less), the vehicle is determined as stopping/parking, and when the speed of the vehicle is substantially greater than zero, the vehicle is determined as not stopping/parking (i.e., traveling).

When the control unit 45 determines that the vehicle is stopping/parking (S7:YES),it proceeds to S8. When the control unit 45 determines that the vehicle is not stopping/parking (S7:NO), it returns to S1 to repeat the process therefrom.

The control unit 45, at S8, determines whether a display request for displaying the tag data is received as an operation input from the operation switch group 40 or to the wireless remote controller 41. In other words, whether a user operation requesting the tag data display is received or not is determined. If the user operation requesting the tag data display has been received (S8:YES), the control unit 45 proceeds to S9. If the user operation has not yet been received (S8:NO), the control unit 45 repeats S8.

The operation switch group 40 and the wireless remote controller 41 may have a mechanical button for instructing the display of the recorded tag data, or the display device 38 may display a button on the screen to be serving as a touch switch for instructing the display of the recorded tag data.

At S9 a list display process is preformed. Per the list display process, the control unit 45 reads and displays the tag data recorded in the storage device 37 in a form of tag list on the display device 38, by referring to a combination of the tag data and the place and time data stored in the storage device 37. The display of the tag list may only display the music piece titles. The titles in the list may be sorted in an ascending order based on the time data, as a default setting.

Further, the list display process in the present embodiment is configured to be performed when the user operation requesting the display is received. However, the list display process may be performed without any user operation when, for example, the vehicle is determined to be stopping.

The control unit 45, at S10, determines whether a user operation for selecting one entry of the tag data listed is received from the operation switch group 40 or the wireless remote controller 41. In other words, whether the user operation of requesting a tag data selection has been received or not is determined. If the user operation requesting the tag data selection has been received (S10:YES), the control unit 45 proceeds to S11. If the user operation requesting the tag data selection has not been received (S10:NO), the control unit 45 repeats S10. The control unit 45 may be referred to as a data selection unit in claims.

The operation switch group 40 and the wireless remote controller 41 may have a mechanical button for selecting one entry of the recorded tag data, or the display device 38 may display a button on the screen to be serving as a touch switch for selecting one entry of the recorded tag data.

In the present embodiment, the display device 38 displays, on the screen, tag selection buttons that respectively serve as touch switches, for the selection of each of many entries of the displayed tag data.

The control unit 45, at S11, performs a detail display process for the tag data selected (i.e., the selected tag data hereinafter) at S10. The detail display process reads and displays the place and time data corresponding to the selected tag data from the storage device 37, and the display device 38 displays the selected tag data in a manner that associates the selected tag data with the place and time data. The control unit 45 may be referred to as a display control unit in claims.

In an example of the present embodiment, the display of the selected tag data on the display device 38 is associated with the travel section. For instance, the display device 38 may display the travel position of the vehicle at the time the music piece corresponding to the selected tag data was being played, a place name of the place that is close to such travel position, and the time at which the music piece was being played. Further, the detail display process controls the display device 38 to display a transfer inquiry that asks the user whether a transfer of the selected tag data to the portable terminal 5 is required.

Further, a touch panel realized as a combination of the display device 38 and the operation switch group 40 in the present embodiment displays a send button for instructing a transfer of the selected tag data to the portable terminal 5 and a delete button for deleting the selected tag data.

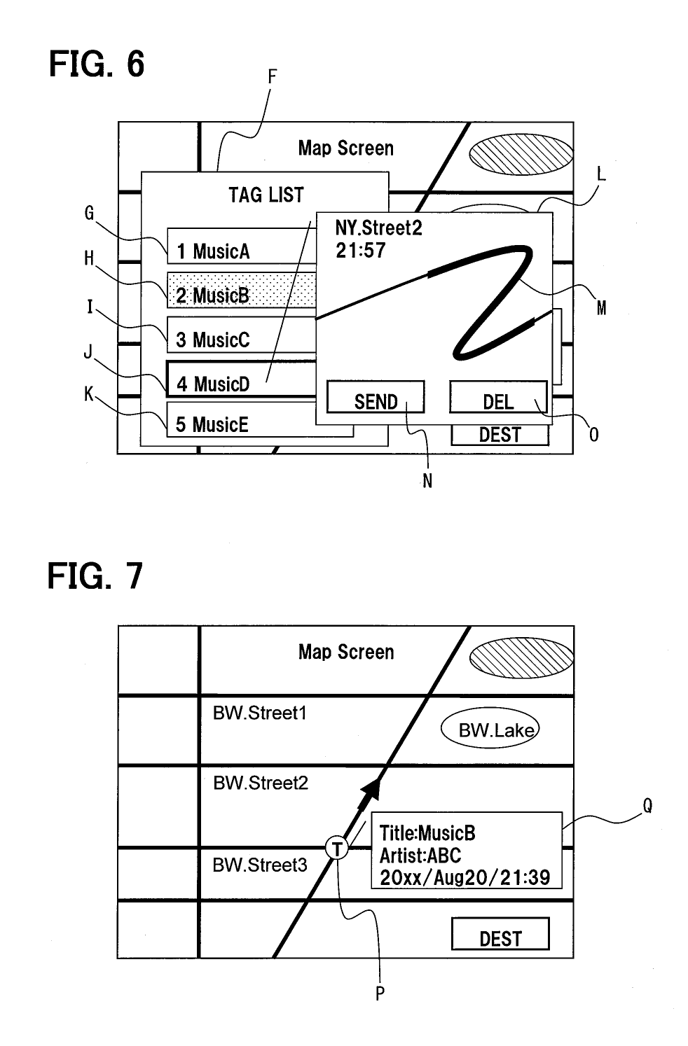

FIG. 6 illustrates an example of the display device 38 based on the detail display process. According to FIG. 6, the tag list (F) includes tag data (G to K). Further, a display associated with the selected tag data (i.e., L is the display associated with the selected tag data J) is also provided. The display of the selected tag data (i.e., L) includes a travel section (M), a send button (N) for instructing the transfer of the selected tag data to the portable terminal 5, and a delete button (O) for deleting the record of the selected tag data. A combination display of the send button (N) and the delete button (O) corresponds to the display of the transfer inquiry asking the user whether a transfer of the selected tag data to the portable terminal 5 is required.

The selected tag data in the tag list (i.e., J) may be highlighted by having, for example, a frame that is a different color from the other tag data entries to distinguish the selected tag data in the tag data list.

The display of the selected tag data (i.e., L) is only provided for the selected tag data. The travel section (i.e., M), which includes the travel position of the vehicle at a time of playback of the music piece corresponding to the selected tag data, is displayed on the travel route of the vehicle in a superposing manner. The place name of a place that is close to such travel position may be displayed as a text, for example, “NY Street 2”, and the time of the playback of the music piece may also be displayed as a text, for example, “21:57.” Further, the display of the “send button” (N) for transferring the selected tag data to the terminal 5 and the “delete button” (O) for deleting the record of the selected tag data is performed at the same time as the display of the travel section, the place name, and the time.

With continuing reference to FIG. 5, at S12, the control unit 45 determines whether a transfer of the selected tag data is required. For instance, is a user operation for instructing a transfer of the selected tag data to the portable terminal 5 is received by the “send button” on the screen, the control unit 45 determines that transfer of the selected tag data is required (S12:YES). If the user operation has been received by the “delete button,” the process determines that the transfer of the selected tag data is not required and the deletion of the selected tag data is required (S12:NO). Accordingly, the control unit 45 may be referred to as a requirement determination unit in claims.

The control unit 45 does not perform S8 to S11 when, for example, it is determined that the vehicle is not stopping/parking (S7:NO), and is resumed when it is later determined that the vehicle is stopping/parking (S7:YES).

The control unit 45 performs a transfer process, at S13, and then returns to S1 to repeat the process. The transfer process transfers the selected tag data to the portable terminal 5 via the portable communication unit 44. In such manner, the selected tag data that is required by the user is transferred to the portable terminal 5. Further, the selected tag data may be gray-shaded in the tag list, i.e., an entry H, as shown in FIG. 6, indicating the transferred status of the tag data.

The control unit 45 performs a record delete process at S14, and then returns to S1 to repeat the process. The record delete process deletes a record of the selected tag data as well as the place and time data associated therewith from the storage device 37. The control unit 45 may be referred to as a record delete unit in claims. In such manner, the tag data that is no longer required is deleted from the storage device 37.

According to the above-described configuration, the tag data is auto-recorded while the vehicle is traveling and eliminates the tag data record operation by the user, thereby not disturbing the driver who is concentrated on driving the vehicle and secures the recording of the tag data.

Further, when the user confirms the tag data while the vehicle is stopping/parking, the associated place data of the tag data is also displayed on the screen, thereby allowing the user to identify the travel position of the vehicle at a time of playback of the music piece. Therefore, based on the memory of the user, using the travel position as a clue, the tag data of the music piece, which was being played back during the travel of the vehicle, is more easily recognized.

Furthermore, when the user confirms the tag data while the vehicle is stopping/parking, the tag data associated time data is also displayed on the screen, thereby allowing the user to identify the time or time slot of playback of the tag data associated music piece. Therefore, based on the memory of the user, using the time or time slot, in addition to the travel position, identified in the above-described manner as a clue, the tag data of the music piece, which was being played back during the travel of the vehicle, is further easily recognized.

The tag data that accords with the inferred user preference is automatically and selectively recorded, and the amount of the tag data to be recorded is reduced. The music pieces that accord with the inferred user reference are more preferably listened to by the user when the vehicle is traveling. Therefore, the present disclosure facilitates, or achieves the higher possibility of, recording of the tag data of the user preferred music pieces to the storage device 37, without increasing the amount of records of tag data.

In addition, the tag data of the music piece being played back at a time of detecting a positive user condition or a positive change of the user condition, such as a recovery from sleepiness, a lightened fatigue, or an improvement of concentration, is selectively recorded, thereby reducing the amount of tag data recorded. Therefore, the present disclosure further facilitates, or achieves the higher possibility of, recording of the tag data of the user preferred music pieces in the above-described manner, without increasing the amount of records of the tag data.

The tag data of the music piece played back in a reserved music program is selectively recorded, thereby reducing the amount of tag data to be recorded. According to an input operation, the user reserves a music program that may play back the music pieces that are highly preferred by the user. Therefore, the present disclosure enables the recording of the tag data of the user preferred music piece. Furthermore, the tag data of the music piece that accords with the travel environment of the vehicle is selectively recorded, thereby reducing the amount of tag data recorded.

Based on the present disclosure, the navigation apparatus 3 transfers the tag data (i.e., a transferred tag data) to the portable terminal. The external device communicator 51 of the portable terminal 5 receives the transferred tag data, and outputs it to the main control unit 57. The main control unit 57 communicates with the music piece data delivery center 2 through the center communication unit 55 and acquires information regarding a purchase price of the music piece data of a music piece corresponding to the transferred tag data.

If the information regarding the purchase price of the music piece data indicates that the data is free, the music piece data of the music piece corresponding to the transferred tag data is automatically downloaded from the music piece data delivery center 2. On the other hand, if the acquired information indicates that the music piece data of the music piece corresponding to the transferred tag data is not free, the music piece data is automatically downloaded from the music piece data delivery center 2 only when the purchase price of the music piece data is less than or equal to a preset threshold price.

If the purchase price of the music piece data is greater than the preset threshold price, the download of the music piece data of the music piece corresponding to the transferred tag data is performed only when the user inputs, to the operation unit 53, an operation that allows the purchase of the music piece data in response to an inquiry whether to purchase such music piece data. The preset purchase price may be set by the main control unit 57 according to an input through the operation unit 53 by the user. The main control unit 57 may be referred to as a setting unit in claims.

In the above-described manner, the music piece data of the music piece corresponding to the tag data, which was selected and transferred, is downloaded without bothering the user when the purchase price of the music piece is less than or equal to the preset threshold price, thereby improving the user convenience.

Based on the present disclosure a time data acquired at a playback time of the music piece that corresponds to a collateral data (i.e., tag data) is also displayed on the display unit together with the place data that is associated with the travel position of the vehicle at a time of playback of the music piece. In such manner, with the help of the time data, the user is reminded about the time of the playback of the music piece that corresponds to the collateral data. Therefore, based on the user's memory of what kind of music piece was being played back at or around what time of day, what kind of a music piece corresponds to the collateral data at issue is more easily recognized by the user. In other words, the user is enabled to more easily and correctly associate the collateral data with a music piece.

Additionally, for one of many entries of the collateral data selected by a data selection unit (i.e., the control unit 45), the place data that is associated with the collateral data selected is displayed according to an input operation by the user. Further, the time data, if it has been recorded, is also displayed in association with the collateral data, in addition to the place data. Therefore, the place data and the time data are displayed with the selected entry of the collateral data.

In such manner, only for the selected one of many entries of the collateral data selected by the input operation by the user, the place and time data is displayed in an associated manner. Therefore, the display of the collateral data is simplified in comparison to displaying the place and time data for all of the collateral data entries. Thus, the display of the collateral data together with the place and time data is made to have a much more simplified look for the user.

When the input operation from the user is provided for the determination by a requirement determination unit regarding which one of many entries of the collateral data is not required, the non-required collateral data is deleted by the record delete unit. Thus, a record of the non-required collateral data not required for the user will be deleted.

The required collateral data that is determined by the requirement determination unit according to the input operation from the user is transmitted to the portable terminal carried by the user, thereby moving the user desired collateral data to the portable terminal.

Additionally, the record unit may selectively record, based on a user preference of the music piece from a preference inference unit, the tag data of the user preferred music piece in an automated manner, thereby enabling a reduction of the amount of the collateral data recorded. In other words, by selectively recording the collateral data for the user preferred music pieces, the collateral data recorded reflects the user preference of the music more precisely while reducing the amount of the recorded data.

The record unit may selectively record the collateral data of the music piece that is being played back at a time of detecting a preset user condition by a driver condition detection unit in an automated manner. Due to the selective recording, the collateral data of the user preferred music pieces is more efficiently recorded. That is, the amount of collateral data recorded is reduced because of the selection of the music piece based on the detected user condition indicating a positive user condition or a positive change of the user condition, such as recovery from sleepiness, a reduction of fatigue, or the like.

The record unit may selectively record the collateral data of the music piece played back in the broadcasted music program when the music program is reserved by a reservation unit according to a user input. Due to the selective recording described above, the collateral data of the music pieces preferred by the user is more efficiently recorded. That is, the amount of collateral data recorded is reduced because of the selection of the music piece by focusing on the music program reserved by the user.

Additionally, the record unit may selectively record the collateral data of the music piece that accords with a travel environment detected by a travel environment detection unit in an automated manner. Due to the selective recording, the collateral data of preferred music pieces is more efficiently recorded. That is, the amount of collateral data recorded is reduced because of the selection of the music piece according to the travel environment such as weather around the vehicle, a time of travel of the vehicle as well as geographical features of the travel position of the vehicle.

The portable terminal of a music piece acquisition system automatically acquires the music piece data from the music piece delivery center when a delivery price of the music piece data of the music piece that is associated with the collateral data is less than or equal to a preset price. Therefore, the acquisition of the selected music piece data is performed without troubling the user when the delivery price of the music piece data is cheap enough.

Additionally, the preset price of the music delivery is set by the user input. Therefore, the price condition about an automatic acquisition of the music piece data from the music piece delivery server is determined by the user.

Although the present disclosure has been fully described in connection with the preferred embodiment thereof with reference to the accompanying drawings, it is to be noted that various changes and modifications will become apparent to those skilled in the art.

For instance, the tag data in the storage device 37 is selected according to certain selection criteria that may be changed. For example, without selecting the tag data, the tag data for all of the music pieces being played may be recorded. In such case, S2 and S3 of FIG. 5 is omitted.

The automatic recording of the tag data to the storage device 37 may be changed in the following manner. For example, the data recording to the storage device 37 may be manually performed according to an input operation. In such case, based on the travel, stopping, or parking status of the vehicle determined by the control unit 45, the recording may be automatically performed during the travel of the vehicle and the recording may be manually performed during the stopping or parking of the vehicle.

Further, the switching of the manual/auto recording may be set according to an input operation by the user. In other words, the recording by the automatic mode only or the recording by both of the automatic mode and the manual mode (i.e., two recording methods), may be selected according to the input operation from the user by using the operation switch group 40 or the wireless remote controller 41 to the control unit 45.

The manual mode for manually recording the tag data is described here in more details. The manual mode for manually recording the tag data accepts the tag data record request from the user to the control unit 45 only when the control unit 45 determines that the vehicle is stopping or parking. Such request may be received as the input operation from the user by using the operation switch group 40 or the wireless remote controller 41 to the control unit 45.

After receiving the input operation for requesting the recording of the tag data by the control unit 45, the place and time data acquisition process is performed for recording, to the storage device 37, the tag data that has been acquired immediately before or just after the input operation by the user in association with the place and time data acquired by the place and time data acquisition process, under control of the control unit 45.

Further, the manually-recorded tag data recorded to the storage device 37 may be displayed on the display device 38 in a superposing manner on a map screen, e.g., a route guidance map screen, with the place and time data associated therewith under control of the control unit 45.

The display of the tag data in a superposing manner is illustrated with reference to FIG. 7. FIG. 7 illustrates the map screen with an arrow representing a travel position of the vehicle, and P represents a tag data recorded location. Further, Q represents the tag data and the time data associated with it. In the example of FIG. 7, the tag data is a music piece title and an artist name, and the place data is a travel position of the vehicle at a time of recording the tag data, and the time data is a time of recording the tag data.

Based on the place data in association with the tag data, a mark indicative of the tag data recording location (i.e., P in FIG. 7) is superposed on the travel position of the vehicle at a time of tag data recording on the map screen. Further, in association with such mark, the music piece title “Music B,” and the name of the artist “ABC” as well as time of recording of the tag data “20xx/Aug20/21:31” are displayed in a superposing manner as text on the map screen.

Even in case of manual recording, the transfer inquiry asking whether the transfer of the tag data to the portable terminal 5 is required is displayed. Then, if the operation input from the user instructs the transfer of the selected tag data, the tag data is sent to the portable terminal 5. If the transfer is indicated as not required by the operation input from the user, the tag data is deleted from the storage device 37, and the display of the tag data and the associated place/time data is erased from the map screen.

Further, when both of the manual recording and the automatic recording are performed, the storage device 37 may have at least two buffers, i.e., the first buffer and the second buffer for tag data recording. The first buffer may record the manually-recorded tag data and place and time data and the second buffer may record the automatically-recorded tag data and place and time data.

In such case, the selected data from among the automatically-recorded tag data may not only be transferred to the portable terminal 5 according to the input operation from the user, but may also be transferred from the second buffer to the first buffer, together with the associated place and time data.

Further, the display of the already-transferred tag data may be gray-shaded in the tag list, after the transfer of the tag data to the portable terminal 5 or to the first buffer.

Further, when both of the manual recording and the automatic recording are performed, the selection of to-be-recorded the tag data in the automatic tag recording may be performed based not only on the preference information acquired from the portable terminal 5 but also on an inference result of the user preference analysis performed by the control unit 45 according to the manually-recorded tag data, such as music piece titles, artist names, genres, and music tones.

Further, the automatic recording of the tag data may be performed when an application program for receiving the broadcasted music program on the navigation apparatus 3 is being executed in the background.

Further, though the above-described embodiment shows an example that always displays the place and time data associated with certain tag data, the time data needs not always be displayed.

Though the present disclosure shows an example that uses the navigation apparatus 3, the navigation apparatus 3 may be replaced with a portable terminal that is equipped with a GPS function. In such case, such GPS-equipped portable terminal may also be serving as the portable terminal 5.

The download of music piece data from the music piece data delivery center 2 may also be performed by the navigation apparatus 3, instead of being performed by the portable terminal 5. In such case, an in-vehicle communication module for telematics communication such as a DCM or the like may be used for such download. The automatic download according to the preset purchase price condition may also be performed by the navigation apparatus 3.

Further, various kinds of changes are possible in the range that it showed in a claim and, not the thing that the present disclosure is limited to each embodiment that it stated above, are included in the range of the technology of the present disclosure about the embodiment it puts unit of technology disclosed each by a different embodiment together appropriately, and to be provided.

Such changes and modifications are to be understood as being within the scope of the present disclosure as defined by the appended claims.

What is claimed is:

1. A vehicular apparatus for use in a vehicle to play a music piece based on sound data of the music piece, the vehicular apparatus comprising:
a broadcast data acquisition unit continuously acquiring collateral data of the music piece together with the sound data of the music piece, the collateral data of the music piece being broadcasted by a broadcast station with the sound data and being used to identify the music piece;
a travel position detection unit detecting a travel position of the vehicle;
a place data acquisition unit acquiring place data regarding a place serving as an approximate indicator of the travel position of the vehicle detected by the travel position detection unit;
a record unit automatically recording the collateral data received by the broadcast data acquisition unit and the place data acquired by the place data acquisition unit when the vehicle is traveling, wherein the place data provides the place around which the travel position of the vehicle is located at a time the music piece that is associated with the collateral data acquired by broadcast data acquisition unit is played; and
a display control unit displaying the place data on a display unit, the display of the place data being provided in association with the collateral data recorded by the record unit.

2. The vehicular apparatus of claim 1 further comprising:
a time data acquisition unit acquiring time data representing one of a current time and a time slot, wherein
the record unit further records, when the vehicle is traveling, the time data acquired by the time data acquisition unit at the time the music piece associated with the collateral data acquired by broadcast data acquisition unit is played, and
the display control unit controls the display unit to display the place data and the time data associated with the collateral data recorded by the record unit.

3. The vehicular apparatus of claim 1 further comprising:
a data selection unit selecting one entry of the collateral data displayed in a list form according to an input operation from a user, wherein
the display control unit displays multiple entries of the collateral data in the list form when the multiple entries of the collateral data are recorded by the record unit, and
the display control unit controls the display unit to display a selected entry of the collateral data selected by the data selection unit in association with the place data associated with the collateral data selected.

4. The vehicular apparatus of claim 1 further comprising:
a requirement determination unit determining whether the collateral data is required according to an input operation from a user in response to a requirement inquiry displayed on the display unit; and
a record delete unit deleting a record of the collateral data that is determined as not required by the requirement determination unit, wherein
the display control unit further displays the requirement inquiry when displaying the collateral data with the place data associated with the collateral data.

5. The vehicular apparatus of claim 4 further comprising:
a portable communication unit performing communication with a portable terminal carried by the user, the portable communication unit sending the collateral data to the portable terminal when the collateral data is determined as required by the requirement determination unit.

6. The vehicular apparatus of claim 1 further comprising:
a preference inference unit inferring user preference of the music piece, wherein
the record unit selectively records the collateral data of the music piece based on the user preference of the music piece inferred by the preference inference unit in an automated manner.

7. The vehicular apparatus of claim 1 further comprising:
a driver condition detection unit detecting a user condition of a driver of the vehicle, wherein
the record unit selectively records the collateral data of the music piece that is played at a time of detecting a preset user condition by the driver condition detection unit in an automated manner.

8. The vehicular apparatus of claim 1 further comprising:
a reservation unit scheduling a reservation of recording a music program according to an input operation from a user, the reservation being made for recording the sound data and the collateral data of multiple music pieces sequentially played by the music program being broadcasted by the broadcast station, wherein
the record unit selectively records the collateral data of the music piece played in the music program that is reserved by the reservation unit in an automated manner.

9. The vehicular apparatus of claim 1 further comprising
a travel environment detection unit detecting a travel environment of the vehicle around the travel position regarding at least one of a geographical feature, a weather, and a time slot, wherein
the record unit selectively records the collateral data of the music piece that accords with the travel environment detected by the travel environment detection unit in an automated manner.

10. A music piece acquisition system comprising:
a portable terminal carried by a user;
a vehicular apparatus disposed in a vehicle and including
a broadcast data acquisition unit continuously acquiring sound data and collateral data of a music piece, the sound data and the collateral data being broadcasted together by a broadcast station and the collateral data being used to identify the music piece,
a travel position detection unit detecting a travel position of the vehicle,
a place data acquisition unit acquiring place data regarding a place serving as an approximate indicator of the travel position of the vehicle detected by the travel position detection unit,
a record unit automatically recording the collateral data acquired by the broadcast data acquisition unit and the place data acquired by the place data acquisition unit when the vehicle is traveling, wherein the place data provides the place around which the travel position of the vehicle is located at a time the music piece associated with the collateral data acquired by the broadcast data acquisition unit is played,
a display control unit displaying the place data on a display unit, the display of the place data being provided in association with the collateral data recorded by the record unit,
a requirement determination unit determining whether the collateral data is required according to an input operation from a user in response to a requirement inquiry, wherein the display control unit displays the requirement inquiry when displaying the collateral data and the place data associated with the collateral data, and
a portable communication unit communicating with the portable terminal and sending the collateral data to the portable terminal when the collateral data is determined as required by the requirement determination unit; and
a music piece delivery center delivering music piece data for the music piece being identified by the portable terminal, wherein
the portable terminal automatically acquires the music piece data from the music piece delivery center when a delivery price of the music piece data of the music piece associated with the collateral data transferred from the vehicle apparatus is less than or equal to a preset price.

11. The music piece acquisition system of claim 10 further comprising:
a setting unit setting the preset price according to an operation by the user.
